(19) United States
(12) Patent Application Publication
(10) Pub. No.: US 2002/0102382 A1
(43) Pub. Date: Aug. 1, 2002

(54) Water dispersible finishing compositions for fibrous substrates

(75) Inventors: Gary W. Kwong, Falcon Heights, MN (US); Mitchell T. Johnson, St Paul, MN (US); Malcolm B. Burleigh, St.Paul, MN (US)

Correspondence Address: Michaele A. Hakamaki, Office of Intellectual Property Counsel, 3M Innovative Properties Company, P.O.Box 33427, St. Paul, MN, 55133-3427, US

(73) Assignee: 3M Innovative Properties Company

(21) Appl. No.: 09/728,857

(22) Filed: Dec. 1, 2000

(51) Int. Cl. B32B 27/04; B32B 33/00

(52) U.S. Cl. 428/96; 442/79; 442/85; 442/93

(57) ABSTRACT

The invention relates to water dispersible finishing compositions for fibrous substrates including fibers, fabrics, carpets, nonwoven webs, and the like. The finishing compositions can impart to the fibrous substrate soil resistance and a range of hydrophilic properties from water repellency to water absorbency. Preferably, the finishing compositions can impart stain resistance to the fibrous substrate. The invention also relates to methods for treating fibrous substrates with the finishing compositions of this invention. The compositions can be applied to the substrate and subsequently cured at ambient temperature or above.

### FIELD OF THE INVENTION

The invention relates to finishing compositions that can be dispersed in water and applied to fibrous substrates such as fibers, fabrics, carpets or nonwoven webs and subsequently cured to impart to the substrate soil resistance as well as a range of hydrophilic properties from water repellency to water absorbency.

### BACKGROUND OF THE INVENTION

The treatment of fibrous substrates with fluorochemical compounds rendering them repellant to water and resistant to soiling and staining has been known in the art for many years. Fluorochemical repellent compositions are described in U.S. Pat. No. 5,672,651 (Smith), U.S. Pat. No. 5,350,795 (Smith et al.), U.S. Pat. No. 5,738,687 (Kamrath et al.), U.S. Pat. No. 4,264,484 (Patel), U.S. Pat. No. 6,074,436 (Wang et al.), and WO 98/50616 (Clark et al.). Although these materials have performed well in terms of water and stain repellency, there is growing concern about health and environmental issues associated with some fluorochemical compounds. This invention provides finishing compositions that are free of fluorochemicals.

Aqueous polyurethane dispersions have been used to impart moisture resistance to textiles. For example, WO 00/37535 (Moore) discloses dispersions that can be used to prepare polyurethane carpet backings and polyurethane textile backings. Additionally, U.S. Pat. No. 6,048,925 (Titterington et al.), U.S. Pat. No. 5,773,490 (Shikinami et al.), U.S. Pat. No. 4,180,491 (Kim et al.), U.S. Pat. No. 3,402,148 (Sutker et al.), U.S. Pat. No. 3,362,780 (Kuth et al.), U.S. Pat. No. 4,082,703 (Duffey et al.), U.S. Pat. No. 5,164,421 (Kiamil et al.), and EP 0 335 276 A1 (Anand) disclose various urethane formulations that are water dispersible. However, these compositions do not have the balance of hydrophilic and lipophilic properties desired for a finishing composition.

The invention provides water dispersible finishing compositions comprising one or more urethanes. The invention also provides methods of treating fibrous substrates with the finishing compositions. The finishing compositions show unexpectedly good properties such as soil and stain resistance as well as a range of hydrophilic properties from water repellency to water absorbency. These properties compare favorably with the state-of-the-art fluorochemical compositions.

### SUMMARY OF THE INVENTION

The invention relates to finishing compositions that can be dispersed in water and applied to fibrous substrates such as fibers, fabrics, carpets and nonwoven webs and subsequently cured to impart to the substrate soil resistance and a range of hydrophilic properties from water repellency to water absorbency.

The finishing compositions of this invention comprise one or more urethanes. In one embodiment, the urethanes are prepared by reacting a polyisocyanate, a polyethylene oxide containing at least one hydroxy group, and a long chain aliphatic alcohol. The urethanes typically have a weighted average hydrophilic/lipophilic balance (“HLB”) between about 1 and about 11.

Another aspect of the invention provides a finishing composition comprising one or more urethanes in combination with a stainblocker, an anti-soiling agent, or a mixture thereof Typical stainblockers include, for example, sulfonated aromatic polymers, polymers that are derived from at least one or more α- and/or β-substituted acrylic acid monomers, or hydrolyzed copolymers of at least one or more ethylenically unsaturated monomers with maleic anhydride. Typical anti-soiling agents include, for example, methacrylic ester polymers, colloidal alumina, colloidal silica, silsesquioxanes, polyvinylpyrrolidone, and water-soluble condensation polymers.

The invention provides a method for treating fabric substrates with the finishing compositions of this invention. The invention also provides a treated fibrous substrate comprising a fibrous substrate treated with the finishing compositions of this invention.

### DETAILED DESCRIPTION OF THE INVENTION

The invention relates to finishing compositions dispersible in water for treating fibrous substrates including fibers, fabrics, carpets, nonwoven webs, and the like. The finishing compositions can impart to the fibrous substrate soil resistance and a range of hydrophilic properties from water repellency to water absorbency. Preferably, the finishing compositions can impart stain resistance and soil resistance to the fibrous substrate. The invention also relates to methods for treating fibrous substrates with the finishing compositions of this invention. The compositions can be applied to the substrate and subsequently cured at or above ambient temperature. As used herein, the term “cure” means that the finishing composition dries to form a film having thermoplastic properties.

The finishing compositions of this invention comprise one or more urethanes. In one embodiment, the urethanes are prepared from the reaction product of a polyisocyanate, a long chain aliphatic alcohol, and a polyethylene oxide containing at least one hydroxy group.

The polyisocyanate includes diisocyanates, triisocyanates, and mixtures thereof Preferably, the polyisocyanate is a triisocyanate. The polyisocyanate includes aliphatic, alicyclic, araliphatic, or aromatic compounds that may be used either singly or in a mixture of two or more. Suitable aromatic polyisocyanates include, for example, 2,4-toluene diisocyanate (TDI), 2,6-toluene diisocyanate, an adduct of TDI with trimethylolpropane (available as DESMODUR™ CB from Bayer Corporation, Pittsburgh, Pa.), the isocyanurate trimer of TDI (available as DESMODUR™ IL from Bayer Corporation), diphenylmethane 4,4′-diisocyanate (MDI), diphenylmethane 2,4′-diisocyanate, 1,5-diisocyanato naphthalene, 1,4-phenylene diisocyanate, 1,3-phenylene diisocyanate, 1-methoxy-2,4-phenylene diisocyanate, 1-chlorophenyl-2,4-diisocyanate, and mixtures thereof

Alicyclic polyfunctional isocyanate compounds include, for example, bis(4-isocyantocyclohexyl)methane (H₁₂MDI, available as DESMODUR™ W from Bayer Corporation, Pittsburgh, Pa.), 4,4′-isopropyl-bis(cyclohexylisocyanate), isophorone diisocyanate (IPDI), cyclobutane-1,3-diisocyanate, cyclohexane 1,3-diisocyanate, cyclohexane 1,4-diisocyanate (CHDI), 1,4-cyclohexanebis(methylene isocyanate) (BDI), 1,3-bis(isocyanatomethyl)cyclohexane (H6XDI), 3-isocyanatomethyl-3,5,5-trimethylcyclohexyl isocyanate (available as DESMODUR™ I from Bayer Corporation), and mixtures thereof

Aliphatic polyfunctional isocyanate compounds include, for example, tetramethylene 1,4-diisocyanate, hexamethylene 1,4-diisocyanate, hexamethylene 1,6-diisocyanate (HDI, available as DESMODUR™ H from Bayer Corporation), octamethylene 1,8-diisocyanate, 1,12-diisocyanatododecane, 2,2,4-trimethyl-hexamethylene diisocyanate (TMDI), 2-methyl-1,5-pentamethylene diisocyanate, dimer diisocyanate, the urea of hexamethylene diisocyanate (HDI), the biuret of hexamethylene 1,6-diisocyanate (HDI) (available as DESMODUR™ N-100 and N-3200 from Bayer Corporation, Pittsburgh, Pa.), the isocyanurate of HDI (available as DESMODUR™ N-3300 and DESMODUR™ N-3600 from Bayer Corporation), a blend of the isocyanurate of HDI and the uretdione of HDI (available as DESMODUR™ N-3400 available from Bayer Corporation), and mixtures thereof.

Araliphatic polyisocyanates include, but are not limited to, those selected from the group consisting of m-tetramethyl xylylene diisocyanate (m-TNXDI), p-tetramethyl xylylene diisocyanate (p-TMXDI), 1,4-xylylene diisocyanate (XDI), 1,3-xylylene diisocyanate, p-(1-isocyanatoethyl)phenyl isocyanate, m-(3-isocyanatobutyl)phenyl isocyanate, 4-(2-isocyanatocyclohexyl-methyl)phenyl isocyanate, and mixtures thereof

The long chain alcohol used to prepare the urethane comprises a hydroxy group and a long straight or branched chain aliphatic group containing typically from about 12 to about 24 and preferably from about 14 to about 20 carbon atoms. The alcohol is typically hydrophobic or lipophilic and not soluble in water. Long chain hydrocarbon alcohols include stearyl alcohol (C₁₈H₃₇OH), cetyl alcohol (C₁₆H₃₃OH), myristyl alcohol (C14H₂₉OH), and the like. Mixtures of the long chain alcohols can be used. Such alcohols are available from Condea Vista Co. (Houston, Tex.) and from Sigma Aldrich Chemical Co. (Milwaukee, Wis.).

The long chain portion of the alcohol is typically a hydrocarbon but can include one or more heteroatoms such as oxygen, sulfur or nitrogen interrupting the carbon chain that do not provide additional sites capable of reacting with a polyisocyanate. Examples include esters, ethers, substituted amines, and the like.

The polyethylene oxide used to prepare the urethane typically contains from about 1 to about 200 ethylene oxide units and has at least one hydroxy group capable of reacting with an isocyanate. Preferably, the polyethylene oxide is monofunctional with the other end of the polymer capped with a (C₁ to C₂₄) alkoxy group such as methoxy, ethoxy, stearoxy, myristoxy, and the like. Examples of polyethylene oxide containing only one hydroxy group per molecule include methoxy-capped polyethylene oxides such as CARBOWAX™ 350 (PEO with molecular weight of 350), CARBOWAX™ 550 (PEO with molecular weight of 550), CARBOWAX™ 750 (PEO with molecular weight of 750) and CARBOWAX™ 2000 (PEO with molecular weight of 2000), available from Union Carbide Corporation, South Charleston, W.Va. Other suitable polymers include ethoxylated alcohols such as TOMADOL™ 45-13 (a polymer containing 13 ethylene oxide units reacted with a linear C₁₄-C₁₅ alcohol), TOMADOL™ 25-12 (a polymer containing 12 ethylene oxide units reacted with a linear C₁₂-C₁₅ alcohol) and TOMADOL™ 1-9 (a polymer containing 9 ethylene oxide units reacted with a linear C₁₁ alcohol), available from Tomah Products, Milton, Wis. Ethoxylated alkyl phenols such as, for example, TRITON™ X-100, TRITON™ X-102, and TRITON™ X-165 (available from Union Carbide Corporation, South Charleston, W.Va.) can also be used as the polyethylene oxide. A monofunctional polyethylene oxide can be combined with a polyethylene oxide diol such as, for example, CARBOWAX™ 1450 (a PEO diol with molecular weight of 1450) available from Union Carbide Corporation.

The urethane of the invention typically has a polyethylene oxide content in the range of about 5 to about 55 weight percent based on the weight of the urethane. Preferably, the polyethylene oxide content is between about 10 to about 40 weight percent and more preferably between about 20 to about 35 weight percent based on the weight of the urethane. The polyethylene oxide group typically imparts hydrophilic characteristics to the urethane. If the content of polyethylene oxide is sufficiently high, the urethanes can be self-emulsified in water.

The polyisocyanate, polyethylene oxide, and long chain alcohol can be reacted using a standard urethane catalyst such as, for example, organo-tin compounds, organo-zirconium compounds, tertiary amines, strong bases, and ammonium salts. If the reaction temperature is sufficiently high, no catalyst is needed.

Organo-tin catalysts include dibutyltin dilaurate, dibutylbis(laurylthio)stannate, dibutyltinbis(isooctylmercaptoacetate), dibutyltinbis(isooctylmaleate), and the like. Organo-zirconium compounds include, for example, zirconium chelates such as K-KAT™ 4205, K-KAT™ XC-6212, K-KAT™ XC-9213 and K-KAT™ XC-A209 from King Industries, Norwalk, Conn.. Tertiary amines include, for example, 2,4,6-tris(N,N-dimethylaminomethyl)-phenol, 1,3,5-tris(dimethylaminopropyl)hexahydro-s-triazine (Dabco), pentamethyldipropylenetriamine, bis(dimethylamino ethyl ether), pentamethyldiethylenetriamine, dimethylcyclohexylamine, and the ammonium salts of these compounds. Strong bases include potassium acetate, potassium 2-ethylhexanoate, amine-epoxide combinations, and the like.

The reaction to form a urethane can be completed either in the absence of a solvent or in the presence of an aprotic solvent such as n-butyl acetate, toluene, methyl isobutyl ketone, and the like. Mixtures of aprotic solvents can be used. The urethane can be prepared by initially reacting either the polyethylene oxide or the long chain alcohol with the polyisocyanate followed by the addition of the other reactant. Alternatively, the polyethylene oxide and long chain alcohol can be placed in the reaction vessel with the polyisocyanate at the same time. Preferably, the polyethylene oxide and the long chain alcohol are first mixed with the solvent. Any water present in the mixture is azeotropically removed before the addition of the polyisocyanate.

The urethanes of this invention typically have a weighted average hydrophilic/lipophilic balance (“HLB”) between about 1 and about 11. As used herein, the term “HLB value” means the hydrophilic/lipophilic balance of each component of the urethane. The term “weighted average HLB value” is defined as the sum of the HLB values of each separate component multiplied by that component's percentage by weight in the urethane. HLB values can be calculated experimentally from partitioning the component between an aliphatic hydrocarbon solvent and water. Alternatively, HLB values can be calculated theoretically based on the structure of the compound by summing empirically derived group numbers for each portion of the structure. For molecules containing polyethylene oxide, the weighted average HLB value can be calculated by dividing the weight percent polyethylene oxide by 5.

The HLB of a mixture of urethanes is calculated as a colligative property. Thus, the HLB of the mixture is the weighted average of the HLB value for all the urethanes in the finishing composition.

Σ(HLBₙ×Fₙ)=HLB_{weighted average}

HLBₙ is the HLB value of a given urethane and Fₙ is the weight fraction of that urethane based on the total weight of all the urethanes in the composition. For example, if the finishing composition contains 70 wt. % urethane 1 with a HLB value of 10 at and 30 wt. % urethane 2 with a HLB value of 5, the weighted average HLB value is 8.5.

(10×0.7)=(5×0.3)=7+1.5=8.5

Compounds with lower HLB values are relatively hydrophobic or lipophilic and have lower water solubility. Such compounds typically have longer hydrocarbon chains and/or a lower degree of ethoxylation. Conversely, components with higher HLB values are relatively hydrophilic and have higher water solubility. Such compounds typically have shorter hydrocarbon chains and/or a higher degree of ethoxylation. For detailed information concerning HLB values and the determination of HLB values, see Schick, Martin J., Nonionic Surfactants, Physical Chemistry, 23, 438-456 (1987). For a listing of commercially available hydrocarbon nonionic surfactants and their corresponding HLB values, see 2000 McCutcheon's, Vol. 1: Emulsifiers and Detergents. North American and International Editions, The Manufacturing Confectioner Publishing Co. (2000).

The weighted average HLB value is typically in the range of about 1 to about 11, preferably in the range of about 2 to about 8, and more preferably in the range of about 4 to about 7. When the weighted average HLB value is less than 2, the finishing composition generally forms droplets on the fibrous substrate. In contrast, when the weighted average HLB is in the range of about 3 to about 11, the finishing composition dries to form a film on the fibrous substrate. The water repellency of the finishing composition typically decreases when the weighted average HLB is greater than about 6.

Another aspect of the invention provides a finishing composition comprising a urethane in combination with a stainblocker, an anti-soiling agent, or mixtures thereof. The urethane comprises a polyisocyanate and a polyethylene oxide containing at least one hydroxy group.

The weighted average HLB value is typically in the range of about 1 to about 11, preferably in the range of about 2 to about 8, and more preferably in the range of about 4 to about 7. To obtain weighted average HLB values in this range, the urethane typically contains one or more long chain aliphatic groups that have hydrophobic or lipophilic properties. These long chain groups can be part of the polyethylene oxide or can be incorporated into the urethane structure through a functional group having an active hydrogen capable of reacting with a polyisocyanate.

Long chain aliphatic groups that are part of the polyethylene oxide include polymers capped with a (C₁₀ to C₂₄) alkoxy group such as stearoxy, myristoxy, and the like. Examples of polymers include TOMADOL™ 45-13 (a polymer containing 13 ethylene oxide units reacted with a linear C₁₄-C₁₅ alcohol), TOMADOL™ 25-12 (a polymer containing 12 ethylene oxide units reacted with a linear C₁₂-C₁₅ alcohol) and TOMADOL™ 1-9 (a polymer containing 9 ethylene oxide units reacted with a linear C₁₁, alcohol) available from Tomah Products, Milton, Wis.

Long chain aliphatic groups that are incorporated into the urethane structure through a functional group include a (C₁₂ to C₂₄) alcohol such as stearyl alcohol, myristyl alcohol, and the like. The long chain portion of the alcohol is typically a hydrocarbon but can include one or more heteroatoms such as oxygen, sulfur or nitrogen interrupting the carbon chain that do not provide additional sites capable of reacting with a polyisocyanate. Examples include esters, ethers, substituted amines and the like.

The polyethylene oxide used to prepare the urethane typically contains from 1 to about 200 ethylene oxide units as well as at least one hydroxy group capable of reacting with an isocyanate. Preferably, the polyethylene oxide contains only one hydroxy group per molecule such as, for example, the methoxy-capped polyethylene oxides CARBOWAX™ 350 (PEO with molecular weight of 350), CARBOEAX™ 550 (PEO with molecular weight of 550), CARBOEAX™ 750 (PBO with molecular weight of 750), and CARBOEAX™ 2000 (PEO with molecular weight of 2000) available from Union Carbide Corporation, South Charleston, W.Va. The total polyethylene oxide content typically is in the range of about 5 to about 55 weight percent based on the weight of the urethane. The polyethylene oxide content is preferably between about 10 to about 40 weight percent and more preferably between about 20 to about 35 weight percent based on the weight of the urethane.

In one preferred embodiment, the urethane is the reaction product of a triisocyanate, a methoxy capped polyethylene oxide with one reactive hydroxy group, and stearyl alcohol. The stearyl alcohol is added to produce a urethane with a weighted average HLB value in the range of about 1 to about 11.

A wide variety of compounds may be used as the stainblocking component including, for example, sulfonated aromatic polymers, polymers derived from one or more α- and/or β-substituted acrylic acid monomers, hydrolyzed copolymers formed from the reaction of one or more ethylenically unsaturated monomers with maleic anhydride, or a combination thereof. Stainblockers can be polymeric or copolymeric blends and can be prepared by polymerizing one or more of the monomers in the presence of one or more of the polymers.

In one embodiment, the stainblocker is a sulfonated aromatic polymer. Sulfonated aromatic polymers include, for example, condensation polymers formed by reacting an aldehyde with a sulfonated aromatic compound and condensation polymers formed by reacting an aldehyde with an aromatic compound followed by sulfonation of the resulting polymer. Aldehydes can include formaldehyde, acetaldehyde, and the like. Suitable sulfonated aromatic compounds include, for example, compounds with hydroxy functionality such as bis(hydroxyphenyl sulfone), hydroxybenzenesulfonic acid, hydroxynaphthalenesulfonic acid, sulfonated 4,4′-dihydroxydiphenylsulfone, and blends thereof. Additionally, sulfonated aromatic compounds can include sulfonated aromatic polymers or copolymers. A copolymer can be formed, for example, between an ethylenically unsaturated aromatic monomer such as styrene and a sulfonated ethylenically unsaturated aromatic monomer such as styrene sulfonate. Applicable sulfonated aromatic polymers are further described in U.S. Pat. No. 4,680,212 (Blyth et al.), U.S. Pat. No. 4,875,901 (Payet et al.), U.S. Pat. No. 4,940,757 (Moss, III et al.), U.S. Pat. No. 5,061,763 (Moss, III et al.), U.S. Pat. No. 5,074,883 (Wang), and U.S. Pat. No. 5,098,774 (Chang).

Commercially available sulfonated aromatic condensation polymers include, for example, Erional™ NW (a polymer formed from the reaction product of naphthalene sulfonic acid, formaldehyde, and 4,4′-dihydroxydiphenylsulfone available from Ciba-Geigy Limited, Ardsley, N.Y.), Erional™ Pa. (a polymer formed by reacting phenol sulfonic acid, formaldehyde, and 4,4′ dihydroxydiphenyl sulfone available from Ciba-Geigy), 3M™ FX-369™ (a fluorochemical stain release concentrate available from 3M, St. Paul, Minn.), Tamol™ SN (a sodium salt of a naphthalene-formaldehyde condensate available from Rohm & Haas Co., Philadelphia, Pa.), Mesitol™ NBS (a fixation agent for anionic direct dyestuffs available from Bayer Corporation, Pittsburgh, Pa.), Bayprotect CL or CSD™ (a stainblocker for nylon carpet available from Bayer Corporation), Nylofixan™ P (a formaldehyde condensation copolymer of 4,4′-dihydroxydiphenylsulfone and 2,4-dimethylbenzenesulfonic acid available from Sandoz Corp., Basle, Switzerland), and Intratex™ N (an auxiliary textile agent available from Crompton & Knowles Corp., Stamford, Conn.). The sulfonated aromatic polymers are typically sold commercially as aqueous solutions with 30 to 40 weight percent solids based on the weight of the solutions. The solutions can contain other compounds such as aromatic sulfonic acids and glycols.

In another embodiment, the sulfonated aromatic polymeric stainblocker contains a small amount of a divalent metal salt in addition to the polymeric materials. Divalent metal salts can include calcium salts, magnesium salts, and the like. The concentration of the divalent salt is typically less than about 0.1 weight percent and preferably less than about 0.05 weight percent based on the weight of the fibrous substrate. The use of divalent metal salts is further described in U.S. Pat. No. 5,098,774 (Chang).

A second class of stainblockers include polymers derived from at least one or more α- and/or β-substituted acrylic acid monomers. These monomers typically have the general structure HR¹C═C(R)COOX, wherein R and R¹ are independently selected from hydrogen, organic radicals, or halogens. X is independently selected from hydrogen, organic radicals, or cations. A preferred group of compounds of this class of stainblockers are acrylic polymers such as, for example, polyacrylic acid, copolymers of acrylic acid with one or more other monomers that are copolymerizable with acrylic acid, or blends of polyacrylic acid with one or more acrylic acid copolymers. More preferred polymers are methacrylic polymers such as, for example, polymethacrylic acid, copolymers of methacrylic acid with one or more other monomers that are copolymerizable with methacrylic acid, or blends of polymethacrylic acid with one or more methacrylic acid copolymers. Monomers useful for copolymerization with either the acrylic acid or the methacrylic acid typically have ethylenic unsaturation such as ethyl acrylate, butyl acrylate, itaconic acid, styrene, sodium sulfostyrene, sulfated castor oil, and the like. Blends of these monomers can be used in copolymerization reactions. Commercially available acrylic polymers useful as stainblockers include AcrySol™ from Rohm and Haas Co. (Philadelphia, Pa.) and Carbopol™ from B.F. Goodrich (Brecksville, Ohio). Commercially available methacrylic polymers include the Leukotan™ family of materials such as Leukotan™ 970, Leukotan™ 1027, Leukotan™ 1028, or Leukotan™ QR1083 available from Rohm and Haas Co. Polymers of α-and/or β-substituted acrylic acid monomers useful in the stainblocking compositions of the invention are further described in U.S. Pat. No. 4,937,123 (Chang et al.), U.S. Pat. No. 5,074,883 (Wang), and U.S. Pat. No. 5,212,272 (Sargent et al.). Another commercially available acrylic polymer is 3M™ FC-672 Protective Chemical from 3M (St. Paul, Minn.).

A third class of stainblocker polymers include hydrolyzed copolymers formed by the reaction of one or more ethylenically unsaturated monomers with maleic anhydride. The ethylenically unsaturated monomers typically include alpha-olefins, alkyl vinyl ethers, aromatic compounds such as styrene, and the like. Suitable alpha-olefins can include, for example, 1-alkenes containing about 4 to about 12 carbon atoms such as isobutylene, 1-butene, 1-hexene, 1-octene, 1-decene, 1-dodecene, and the like. Preferably, the alpha-olefins are isobutylene or 1-octene. A portion of the alpha-olefins can be replaced by one or more other monomers. The stainblocker can contain up to about 50 weight percent of (C₁ to C₄) alkyl acrylates, (C₁ to C₄) alkyl methacrylates, vinyl sulfides, N-vinyl pyrrolidone, acrylonitrile, acrylamide, and the like. Mixtures of these replacements monomers can be used. Hydrolyzed copolymers formed by reacting one or more alpha-olefin monomers with maleic anhydride are further described in U.S. Pat. No. 5,460,887 (Pechhold). U.S. Pat. No. 5,001,004 (Fitzgerald et al.) further describes hydrolyzed copolymers formed by reacting one or more ethylenically unsaturated aromatic monomers with maleic anhydride.

Water-soluble or water-dispersible anti-soiling agent can be incorporated in the finishing composition to further improve the soil resistance of the substrate and render it non-tacky. An anti-soiling agent is typically added to the finishing composition if the weighted average HLB value is above about 4 or the urethane contains greater than about 15 weight percent polyethylene oxide based on the weight of the urethane. Typical additives include, for example, methacrylic ester polymers such as ethyl methacrylate/methyl methacrylate copolymers; colloidal alumina such as CATAPAL™ and DISPAL™ aluminas available from Condea Vista Co., Houston, Tex.; colloidal silica such as NALCO™ silicas available from Nalco Chemical Co., Naperville, Ill.; silsesquioxanes such as those disclosed in U.S. Pat. Nos. 4,781,844, 4,351,736, 5,073,442, and 3,493,424; polyvinylpyrrolidone; and water-soluble condensation polymers formed by the reaction of formaldehyde with urea, melamine, benzoguanamine, or acetylguanamine.

A good correlation exists between receding contact angle measurements in n-hexadecane and the anti-soiling properties of finishing compositions. Consequently, receding contact angle measurements can be used to identify compositions with suitable anti-soiling properties without having to conduct lengthy walk-on soil tests. Thus, for example, urethanes having a receding contact angle of at least about 40° exhibit suitable anti-soiling characteristics.

The invention further provides a method for treating a fibrous substrate with the finishing compositions of this invention. Substrates that can be treated include natural and synthetic fibers, fabrics, carpets, nonwoven webs, and the like. Natural fibrous substrates include cotton, wool, silk, and the like. Synthetic fibrous substrates include polyester, polyolefin, nylon, acrylic, acetate, or blends thereof Preferably, the fibrous substrate is a carpet.

The finishing compositions are typically emulsified to make them water dispersible. Techniques for emulsifying the compositions include sonification, shear, and the like. The treatment comprises the steps of applying the finishing composition to the fibrous substrate and developing the desired properties at or above ambient temperature. Typically, the composition forms a film on the fibrous substrate at room temperature but additional heat can be used for drying after application of the finishing composition.

Any technique customarily used for applying finishes to fibers and fabrics can be used. The compositions of the invention can be applied to the substrate, for example, by spraying, brushing, immersion, foaming, and the like. Generally, the amount of dry finishing composition that is applied to the fiber or fabric is between about 0.05 and about 5 weight percent based on the weight of the substrate. Preferably, the amount of dry finishing composition applied ranges from about 0.2 to about 3 weight percent based on the weight of the substrate. In terms of area of the fibrous substrate, the dry finishing composition is typically in the range of about 0.05 to about 5 grams per square feet (about 0.5 to about 50 grams per square meter) and preferably in the range of about 0.2 to about 3 grams per square feet (about 2 to about 30 grams per square meter).

The invention includes a treated fibrous substrate comprising a fibrous substrate and the finishing compositions of this invention applied thereto.

The following examples further describe the finishing compositions, methods of using the finishing compositions of the invention, and the tests performed to determine the various characteristics of the finishing compositions. The examples are provided for exemplary purposes to facilitate understanding of the invention and should not be construed to limit the invention to the examples.

### EXAMPLES

Unless otherwise specified, all percentages shown in the examples and test methods that follow are percentages by weight. Application of test formulations to fibrous test substrates are described using a pump sprayer method. However, one can also apply test formulations using an aerosol can charged with propellant. The fibrous substrate can be either damp or dry prior to spray application.

### Test Methods

Sprayer Application—A 3M™ AP-1 all-purpose pump sprayer was charged with the test formulation and was affixed with a P-Jet 5001 sprayer nozzle for application to upholstery or was affixed with a P-Jet 8004 sprayer nozzle for application to carpet. The test fibrous substrate was then treated by the test formulation by holding the sprayer nozzle 12 to 24 inches (30 to 60 cm) from the fibrous substrate surface, and spraying the test formulation onto the substrate surface using a sweeping motion of the nozzle. The treated substrate was then allowed to dry and cure for at least a 24-hour period.

Stiffness Rating—The stiffness of the treated substrate was determined using a subjective “hand touch” test scale, with a rating of +5 representing a very soft feel of the fiber to the hand, −5 representing a very stiff hard feeling of the fiber, and 0 representing the touch of untreated fiber.

Strikethrough Time—Strikethrough time, a measure of water repellency, was determined using either deionized water droplets or 90/10 water/IPA droplets using the following test procedure. According to this procedure, six droplets, each approximately 3 to 5 mm in diameter, were placed on the test treated fibrous substrate surface using an eyedropper. The time for each droplet to completely submerge into the treated substrate fibers was measured, then an average time was calculated for the six droplets. This average droplet submersion time procedure was repeated with the same fibrous substrate except that this time the substrate was untreated. The strikethrough time was recorded as the difference in average droplet submersion times between the treated and the untreated fibrous substrates. A longer time correlates with improved water repellency.

Contact Angle Measurement Test—Advancing and receding contact angle measurements were made with a Krüss Processor Tensiometer, Model K-12 (available from Krüss KmbH, Hamburg, Germany), using the Wilhelmy Plate Method. Each candidate was dissolved at 5% in ethyl acetate, methyl isobutyl ketone or toluene, then the solution was applied to either nylon or polyester film.

For advancing contact angle (ACA) measurements, the treated film was suspended, from above the platform, the reservoir on the platform was filled with either n-hexadecane or water, and the platform was raised toward the suspended sample until the sample was completely submerged. The instrument calculated the advancing contact angle as the treated film was being submerged.

For receding contact angle (RCA) measurements, the reverse procedure was followed as with the advancing contact angle measurements, that is, the suspended treated film was first immersed in the n-hexadecane or water, then the platform was lowered so that the film was gradually pulled out of the test liquid. The instrument calculated the receding contact angle as the film was being pulled out. A high receding contact angle measured against n-hexadecane is a good predictor of anti-soiling performance.

Staining Test—Stain resistance of a carpet sample was determined as follows. First, a red staining solution was prepared by dissolving 0.007% of Red Dye FD&C #40 in deionized water, then adjusting the solution pH to 3.0 using 10% aqueous sulfamic acid. The staining solution was adjusted to 22° C., and 5 g of the solution was placed on the topside of a carpet sample inside the confines of a 4 cm diameter template for a period of 2 minutes. Excess staining solution was absorbed through the backside of the carpet sample using a cellulose sponge. The stain was allowed to air dry at 22° C. for 14 hours and then the carpet sample was rinsed using cool water with no agitation until the rinse water remained clear. The stained carpet sample was allowed to air dry at room temperature.

The degree of staining of the carpet sample was determined numerically by using a Minolta 310 Chroma Meter™ compact tristimulus color analyzer. The color analyzer measures red stain color autochromatically on the red-green color coordinate as a “delta a” (Δa) value as compared to the color of an unstained and untreated carpet sample. Measurements reported in the tables below are given to one place following the decimal point and represent the average of 3 measurements, unless stated otherwise. A greater Δa reading indicates a greater amount of staining from the red dye. Δa readings typically vary from 0 (no staining) to 50 (severe staining).

“Walk-On” Soiling Test—The relative soiling potential of each treatment was determined by challenging both treated and untreated (control) carpet samples under defined “walk-on” soiling test conditions and comparing their relative soiling levels. The test is conducted by mounting treated and untreated carpet squares on particle board, placing the samples on the floor of one of two chosen commercial locations, and allowing the samples to be soiled by normal foot traffic. The amount of foot traffic in each of these areas is monitored, and the position of each sample within a given location is changed daily using a pattern designed to minimize the effects of position and orientation upon soiling.

Following a specific soil challenge period, measured in number of cycles where one cycles equals approximately 10,000 foot-traffics, the treated samples are removed and the amount of soil present on a given sample is determined using colorometric measurements, making the assumption that the amount of soil on a given sample is directly proportional to the difference in color between the unsoiled sample and the corresponding sample after soiling. This color difference can be quantified using the three CIE L*a*b* color coordinates of a Minolta 310 Chroma Meter with a D65 illumination source, which is recorded as a ΔE value, the difference in reading from a soiled and unsoiled carpet sample. Such ΔE values have been shown to be qualitatively in agreement with values from older, visual evaluations such as the soiling evaluation suggested by the AATCC, and have the additional advantages of higher precision, being unaffected by evaluation environment or subjective operator differences. Final ΔE values for each sample are calculated as an average of between five and seven replicates. This color measurement procedure is described in detail in ASTM D-6540.

### Glossary

DES N-100—DESMODUR™ N-100, hexamethylene diisocyanate-derived biuret triisocyanate, essentially 100% active, available from Bayer Corp., Pittsburgh, Pa.

DES N-75BA—DESMODUR™ N-75BA, hexamethylene diisocyanate-derived biuret triisocyanate, (essentially a 75% solution of DESMODUR™ N-100 in n-butyl acetate), available from Bayer Corp.

C₁₈H₃₇OH—mixture of 95-96% 1-octadecanol, <3% 1-eicosanol, <3% 1-hexadecanol and <0.5% 1-tetradecanol, available from Condea Vista Co., Houston, Tex.

C₁₆H₃₃OH—ALFOL™ 16 alcohol, available from Condea Vista Co.

C₁₄H₂₉OH—ALFOL™ 14 alcohol, available from Condea Vista Co.

TOM 45-13—TOMADOL™ 45-13, a C₁₄₋₁₅ straight chain alcohol ethoxylate having about 13 ethylene oxide units, available from Tomah Products, Milton, Wis.

TOM 25-12—TOMADOL™ 25-12, a C₁₂₋₁₅ straight chain alcohol ethoxylate having about 12 ethylene oxide units, available from Tomah Products.

TOM 1-9—TOMADOL™ 1-9, a C₁₁ straight chain alcohol ethoxylate having about 9 ethylene oxide units, available from Tomah Products.

MPEG 350—CARBOWAX™ 350, monomethoxy polyoxyethylene alcohol having a molecular weight of approximately 350, available from Union Carbide Corp., South Charleston, W.Va.

MPEG 550—CARBOWAXM 550, monomethoxy polyoxyethylene alcohol having a molecular weight of approximately 550, available from Union Carbide Corp.

MPEG 750—CARBOEAX™ 750, monomethoxy polyoxyethylene alcohol having a molecular weight of approximately 750, available from Union Carbide Corp.

PEG 1450—CARBOWAX™ 1450, polyoxyethylene diol having a molecular weight of approximately 1450, available from Union Carbide Corp.

MPEG 2000—CARBOEAX™ 2000, monomethoxy polyoxyethylene alcohol having a molecular weight of approximately 2000, available from Union Carbide Corp.

T-12—Metacure™ T-12 catalyst (dibutyl tin dilaurate), available from Air Products, Allentown, Pa.

FC-672—3M™ FC-672 Protective Chemical stainblocker, acrylic stain release for polypropylene and polypropylene-blend carpets, available from 3M Company.

Polymer I—Polymer I stainblocker can be prepared as follows. To a 1-L reaction vessel equipped with a reflux condenser, a mechanical stirrer and a thermometer are charged 7.0 g of sulfated castor oil solution (70% solids) and 515.0 g of deionized water. The resulting solution is heated to 95° C., and to this solution are added simultaneously dropwise 198.0 g of methacrylic acid, 45.2 g of butyl acrylate, and 21.6 g of ammonium persulfate in 50 g of water over a period of about 2 hours. The reaction mixture is further stirred for 3 hours at 90° C. and then is cooled to 50° C. The resultant copolymer solution is partially neutralized by the addition of aqueous ammonium hydroxide to bring the pH to 9 to provide a 32 % aqueous dispersion.

EMA/MMA—The 50/50 EMA/MMA copolymer anti-soiling agent can be prepared as follows. To a 2000 gallon (7500 L) pressurized vessel equipped with heater and agitator is added 4330 lb (1970 kg) of deionized water. The agitator is set at 60 rpm, and 263 lb (120 kg) of SERMUL™ EA 151 (35% solution of sodium nonylphenol polyglycol ether (10 EO) sulfate, available from Condea Vista Co.) is added. The batch temperature is held at 100° F. (38° C.) while an additional 4465 lb (2030 kg) of deionized water and an additional 1094 lb (500 kg) of SERMUL™ EA 151 are charged. The vessel is purged with nitrogen at 15 psig (1540 torr) and venting, and while holding the batch at 75° F. (24° C.), 9500 lb (4320 kg) of a 50/50 mixture of ethyl methacrylate/methyl methacrylate is added. The batch is then heated to 122° F. (50° C.) with continued agitation, and a mixture of 18 lb (8.2 kg) of potassium persulfate and 260 lb (118 kg) of deionized water is added. The resulting mixture is periodically purged with nitrogen, and an exotherm will begin in 15-30 minutes after addition. The batch temperature is initially set at 150° F. (60° C.) and is allowed to rise to 185° C. (85° C.) as the polymerization reaction progresses. After about 3 hours, analyze for acrylate monomer; if some is present, add an additional 4 lb (1.8 kg) of potassium persulfate and allow the reaction to proceed for another 1-2 hours. Allow the kettle to cool and recover the copolymer aqueous dispersion, which is typically about 50% solids.

TRANS III—TRANSITION III™ Nylon Carpet, Lees, #LH585, color CR15836 Blue, Solutia Ultron Fiber, Superba heat set, untreated nylon carpet, 36 ounces/yd² (1.3 kg/m²), available from Burlington Industries, Greensboro, N.C.

Water Repellency Test—Fibrous substrates were evaluated for water repellency by challenging them to penetration by a series of test fluids representing blends by volume of deionized water and isopropyl alcohol (IPA). This series of fluids represents aqueous liquids of varying surface tensions for challenging a fibrous substrate. In this 12-point rating test, each fluid is assigned a rating number as shown below in TABLE 1.

TABLE 1

| | | |
|---|---|---|
| Rating | % IPA (volume) | Surface Tension (dynes/cm) |

| | |
|---|---|
| 0 | Not repellent to any test fluid |

| | | |
|---|---|---|
| 1 | 0 | 72 |
| 2 | 1.07 | 68 |
| 3 | 2.21 | 64 |
| 4 | 3.45 | 60 |
| 5 | 4.81 | 56 |
| 6 | 6.32 | 52 |
| 7 | 8.02 | 48 |
| 8 | 10.00 | 44 |
| 9 | 12.39 | 40 |
| 10 | 15.47 | 36 |
| 11 | 20.00 | 32 |
| 12 | 30.00 | 28 |

In running the Water Repellency Test, a fibrous substrate sample is placed on a flat, horizontal surface. Five small drops of test fluid are gently placed at points at least two inches apart on the sample. If, after observing for ten seconds at a 45° angle, four of the five drops are visible as a sphere or a hemisphere, the fibrous substrate is deemed to pass the test for that particular test fluid. The reported water repellency rating corresponds to the highest numbered test fluid for which the treated fabric sample passes the described test. For maximum repellency, it is desirable that this rating be as high as possible. A rating of “zero” indicates no repellency to any test fluid, including pure water.

### Preparation Compounds and Intermediates

The solid urethanes were all emulsified in deionized water using a Branson SONIFIER™ Untrasonic Horn 450 ultrasonic homogenizer (available from VWR Scientific) to produce an emulsion containing 15 percent urethane solids, unless otherwise noted.

Urethane A (0.8/0.2/1.0 C₁₈H₃₇OH/MPEG 750/DES N-100)—This urethane represents the sequential reaction product of 0.2 equivalents of CARBOWAX 750 alcohol with 1.0 equivalent of DESMODUR™ N-100 triisocyanate, followed by reaction of the remaining isocyanate groups with 0.8 equivalents of stearyl alcohol.

In a 3-necked flask equipped with stirrer, heating mantle and thermometer was placed 146 g of toluene, 34.3 g of DES N-100 (0.179 NCO eq), 26.9 g of NPEG 750 (0.036 OH eq), and 0.1 g of dibutyl tin dilaurate (0.1% relative to reactants). The resulting mixture was heated from room temperature to 58° C. with dissolution of the solids occurring over about a 7-minute period. The reaction mixture was further heated from 58° C. to 69° C. over a 23-minute period. The reaction solution was maintained at 65-69° C. and stirred for 82 minutes. Then 38.8 g (0.14 eq) of C₁₈H₃₇OH was added and the resulting mixture was heated at 63-75° C. for 104 minutes, giving a sample showing no remaining isocyanate based on infrared (IR) spectroscopic analysis (indicated essentially 100% reaction of NCO groups). The reaction product solution was poured into an aluminum tray, and the solvent was removed.

Urethane B (0.79/0.21/1.0 C₁₈H₃₇OH/MPEG 550/DES N-75BA)—For this example, both the long chain alcohol and the polyethylene oxide were reacted together with the triisocyanate, in contrast to the preparation of Urethane A, wherein the polyethylene oxide was first reacted with the triisocyanate followed by reaction with the long chain alcohol.

A mixture of 51.0 g of methyl isobutyl ketone (MIBK), 46.2 g (0.084 eq) of MPEG 550 and 85.3 g (0.316 eq) of C₁₈H₃₇OH was charged to a 3-necked flask equipped with stirrer, heating mantle, thermometer, addition funnel and distillation trap. The resulting mixture was heated from 23° C. to 126° C. and maintained at 126° C. for over 2½ hours, giving 3.6 mL of an azeotrope in the trap. The mixture was stirred for an additional 25 minutes, giving rise to a total of 4.8 mL (3.9 g) collected in the distillation trap. The mixture was allowed to cool from 127° C. to 75° C. over a 17-minute period. Then 0.23 g (0.1% based on reactant solids) of T-12 catalyst dissolved in 4.9 g of MIBK was added. Then 102.1 g (0.40 eq) of DES N-75BA was added dropwise over a 40-minute period at a temperature ranging from 71.5-75° C. IR analysis of an aliquot of reaction product showed 0.11 (wt)% unreacted NCO, indicating about 97.9% completion of reaction. The pressure-equalizing addition funnel was rinsed out with MIBK (total of 31.5 g). The resulting solution was stirred at 67-71° C. for 40 minutes to further drive the reaction to completion. IR analysis of an aliquot showed 0.01(wt)% NCO, indicating about 99.8% completion of reaction.

The solution was poured into an aluminum pan, heated overnight in a 150° F. (65° C.) oven, yielding a white solid.

Urethanes C-L—Urethanes C-L were each prepared using essentially the same mixed polyethylene glycol/stearyl alcohol reaction with triisocyanate as described for preparing Urethane B (including azeotropic distillation of hydroxyl functional components prior to reacting with isocyanate), except that variations were made in the polyethylene oxide (MPEG 750, MPEG 500, MPEG 350 monofunctional methoxy-terminated polyethylene oxides or PEG 1450 difunctional polyethylene oxide) and triisocyanate (DES N-100 or DES N-75BA) and in the ratio of equivalents of all three reactants. Urethane J was made from four reactants, as two polyethylene oxides were used. Urethane K, a comparative urethane, was made by reacting equivalent amounts of C₁₈H₃₇OH and DES N-100, with no polyethylene oxide included. These urethanes, along with Urethane A and B, are summarized in TABLE 2, along with the weighted average HLB value and percent polyethylene oxide calculated for each urethane.

TABLE 2

| Urethane | Reaction Mixture | Eq. Ratio | HLB | % PEO |
|---|---|---|---|---|
| A | C₁₈H₃₇OH/PEG 750/DES N-100 | 0.8/0.2/1.0 | 5.1 | 25.7 |
| B | C₁₈H₃₇OH/MPEG 550/DES N-75BA | 0.79/0.21/1.0 | 4.2 | 21.0 |
| C | C₁₈H₃₇OH/MPEG 750/DES N-75BA | 0.9/0.1/1.0 | 2.8 | 14.1 |
| D | C₁₈H₃₇OH/MPEG 750/DES N-75BA | 0.85/0.15/1.0 | 4.0 | 20.2 |
| E | C₁₈H₃₇OH/MPEG 750/DES N-75BA | 0.75/0.25/1.0 | 6.2 | 30.9 |
| F | C₁₈H₃₇OH/MPEG 750/DES N-75BA | 0.7/0.3/1.0 | 7.1 | 35.6 |
| G | C₁₈H₃₇OH/MPEG 750/DES N-75BA | 0.5/0.5/1.0 | 10.2 | 51.1 |
| H | C₁₈H₃₇OH/MPEG 750/DES N-75BA | 0.3/0.7/1.0 | 12.6 | 63.0 |
| I | C₁₈H₃₇OH/MPEG 750/DES N-75BA | 0.1/0.9/1.0 | 14.5 | 72.3 |
| J | C₁₈H₃₇OH/MPEG 750/PEG 1450/DES N-75BA | 0.65/0.25/0.15/1.0 | 8.0 | 40.1 |
| K | C₁₈H₃₇OH/DES N-100 | 1.0/1.0 | 0 | 0 |
| L | C₁₈H₃₇OH/MPEG 350/DES N-75BA | 0.68/0.32/1.0 | 4.2 | 20.9 |

Urethane M (0.8/0.2/1.0 C₁₈H₃₇OH/PEG 1450/DES N-100)—In a 3-necked flask equipped with stirrer, heating mantle and thermometer was placed 146 g of toluene, 34.6 g of DES N-100 (0.181 NCO eq), 26.2 g of PEG 1450 (0.036 OH eq), and 0.10 g of T-12 catalyst (0.1% relative to reactants). The resulting mixture was heated from room temperature to 61.5° C. with dissolution of the solids occurring over about a 7-minute period. The reaction mixture was further heated from 61.5° C. to 66° C. over a 17 minutes period, and the reaction mixture was maintained at 65-72° C. and stirred for an additional 88 minutes. Then 39.1 g (0.145 eq) of C₁₈H₃₇OH was added, and the resulting mixture was heated at 69-76° C. for 48 minutes, giving a sample showing 0.04% isocyanate based on IR absorption (indicated 98.7% reaction of NCO groups). The reaction product solution was stirred at 69-73° C. for an additional 82 minutes, poured into an aluminum tray, and the solvent was removed. From calculation, the weighted average HLB value of the urethane solid was 5.2 and the percent polyethylene oxide was 25.9.

Urethane N (0.7/0.3/1.0 C₁₈H₃₇OH/TOM 45-13/DES N-75BA)—Into a 3-necked flask equipped with stirrer, heating mantle, thermometer and distillation trap was placed 64.3 g (0.238 eq) of C₁₈H₃₇OH, 80.6 g (0.102 eq) of TOM 45-13 and 58.3 g of MIBK. The resulting mixture was heated at 108-125° C. for 84 minutes to form a solution, with collection of 0.5 g of azeotrope. The solution was allowed to cool to 79° C. over a 38-minute period, and 0.231 g of dibutyl tin dilaurate (0.1% relative to reactants) was added. Then, maintaining the temperature at 65-70° C., 86.6 g (0.34 eq) of DES N-75BA was added dropwise over a 43-minute period, followed by 26.9 g of additional MIBK to rinse the addition funnel. A sample of the solution was removed and analysis showed 0.12% unreacted NCO, indicating 97.2% reaction. The solution was stirred at 68-70° C. for an additional 57 minutes, the solution was then poured into an evaporation tray, the tray with solution was placed in a 100° C. forced air oven for 16 hours to provide 213.2 g of a white solid (101% yield).

Urethanes O-R—Urethanes O-R were each prepared using essentially the same sequential reaction procedure as described for preparing Urethane N, except that variations were made in the polyethylene oxide composition and equivalents ratio to isocyanate (polyethoxylated alcohols TOM 1-9, TOM 25-12 or TOM 45-13, at 0.2 or 0.3 eq) while the long chain hydrocarbon alcohol was kept at C₁8H₃₇OH (at 0.8 or 0.7 eq).

The composition of Urethanes O-R, along with Urethane N, are summarized in TABLE 3, along with the weighted average HLB value and the % polyethylene oxide calculated for each urethane.

TABLE 3

| Urethane | Reaction Mixture | Eq. Ratio | HLB | % PEO |
|---|---|---|---|---|
| N | C₁₈H₃₇OH/TOM 45-13/DES N-75BA | 0.7/0.3/1.0 | 5.5 | 27.6 |
| O | C₁₈H₃₇OH/TOM 25-12/DES N-75BA | 0.7/0.3/1.0 | 5.2 | 26.2 |
| P | C₁₈H₃₇OH/TOM 25-12/DES N-75BA | 0.8/0.2/1.0 | 3.8 | 18.9 |
| Q | C₁₈H₃₇OH/TOM 45-13/DES N-75BA | 0.8/0.2/1.0 | 4.0 | 20.1 |
| R | C₁₈H₃₇OH/TOM 1-9/DES N-75BA | 0.8/0.2/1.0 | 3.0 | 15.2 |

Urethane S (0.935/0.065/1.0 C₁₈H₃₇OHI/PEG 2000/DES N-75BA)—50.0 g of MIBK, 45.5 g (0.0228 eq) of PEG 2000 and 88.4 g (0.327 eq) of C₁₈H₃₇OH were charged to a 3-necked flask equipped with stirrer, heating mantle, thermometer, addition funnel and distillation trap. The resulting mixture was heated from 23° C. to 122° C. over a 1 hour period to give a 70% solids solution, and the solution was kept at 118-122° C. for 115 minutes while sweeping with nitrogen, giving 3.2 g of distillate in the trap. The solution was cooled from 120° C. to 67° C. and was maintained at 67° C. about 2 hours. Then a mixture of 0.22 g of T-12 catalyst (0.1% relative to reactants) and 4.9 g of MIBK was added to the solution, followed by dropwise addition of 89.1 g (0.35 eq) of DES N-75 BA over 54 minutes, keeping the solution at 60-69° C. After an additional 2 minutes at 61° C. , an aliquot was taken and showed no remaining NCO bands by FTIR analysis. The solution was stirred at 60-65° C. for an additional hour, then the solution was poured into an aluminum tray and the solvent was removed, yielding a white solid.

Urethane T (0.85/0.15/1.0 C₁₄H₂₉OH/MPEG 750/DES N-75BA)—39.0 g of MIBK, 49.5 g (0.066 eq) of MPEG 750 and 80.0 g (0.374 eq) of C₁₄H₂₉OH were charged to a 3-necked flask equipped with stirrer, heating mantle, thermometer, addition funnel and distillation trap. The resulting mixture was heated from 23° C. to 11 8° C. and was maintained at 11 8° C. over an 80 minute period while sweeping with nitrogen, giving 5.2 g of distillate in the trap. The solution was cooled from 11 8° C. to 68° C. over a 40-minute period. Then 0.24 g of T-12 catalyst (0.1% relative to reactants) and 4.0 g of MIBK was added, followed by dropwise addition of 112.1 g (0.440 eq) of DES N-75 BA over a 30 minute time period, maintaining the temperature at 68-73° C. After an additional 2 minutes at 70° C., an aliquot was taken and showed 0.08% NCO remaining according to FTIR analysis, indicating about 98% completion of the reaction. The solution was stirred at 70.5-72° C. for an additional 46 minutes, then the solution was poured into an aluminum tray and the solvent was removed, yielding a white solid.

Urethane U (0.85/0.15/1.0 C₁₆H₃₃OH/MPEG 750/DES N-75BA)—39.0 g of MIBK, 46.1 g (0.062 eq) of MPEG 750 and 84.3 g (0.349 eq) of C₁₆H₃₃0H were charged to a 3-necked flask equipped with stirrer, heating mantle, thermometer, addition funnel and distillation trap. The resulting mixture was heated from 23° C. to 122° C. and was maintained at 122° C. over a 1 hour period while sweeping with nitrogen, giving 3.0 g of distillate in the trap. The solution was cooled from 122° C. to 73° C. over a 33-minute period. Then 0.23 g of T-12 catalyst (0.1% relative to reactants) and 4.0 g of MIBK was added, followed by dropwise addition of 104.4 g (0.41 eq) of DES N-75 BA over a 40 minute time period, maintaining the temperature at 68-77° C. Then an aliquot was taken and showed 0.08% NCO remaining according to FTIR analysis, indicating about 98% completion of the reaction. The solution was stirred at 67-72° C. for an additional 57 minutes, then the solution was poured into an aluminum tray and the solvent was removed, yielding a white solid. An emulsion was made of the urethane in water containing 25 % solids.

### Examples 1-14 and Comparative Example C1-C3

In Examples 1-14, Urethanes A-G, J, L and N-R were evaluated for advancing contact angles (ACA) and receding contacts angles (RCA) vs. water and n-hexadecane, using the Contact Measurement Test. Results of these contact angle measurements are presented in TABLE 4, along with the calculated weighted average HLB value and % polyethylene oxide for each urethane arranged in increasing order.

In Comparative Example C1, Urethane K, a urethane having no polyethylene oxide and thus outside the scope of this invention, was evaluated. Urethane K represents the reaction product of equivalent amounts of C₁₈H₃₇OH and DES N-100 and contains no PEO.

In Comparative Examples C2-C3, Urethanes H and I, having over 60% PEO and weighted average HLB values of greater than 12, also outside the scope of this invention, were evaluated.

TABLE 4

| | | Water: | | n-Hexadecane: | | | % |
|---|---|---|---|---|---|---|---|
| Ex. | Urethane | ACA | RCA | ACA | RCA | HLB | PEO |
| C1 | K | 94 | 84 | 52 | 42 | 0 | 0 |
| 1 | C | 95 | 56 | 52 | 40 | 2.8 | 14.1 |
| 2 | R | 97 | 72 | 52 | 31 | 3.0 | 15.2 |
| 3 | P | 89 | 56 | 53 | 26 | 3.8 | 18.9 |
| 4 | Q | 95 | 60 | 53 | 32 | 4.0 | 20.1 |
| 5 | D | 97 | 58 | 53 | 42 | 4.0 | 20.2 |
| 6 | L | 97 | 63 | 54 | 42 | 4.2 | 20.9 |
| 7 | A | 84 | 62 | 48 | 42 | 5.1 | 25.7 |
| 8 | M | 109 | 81 | 48 | 42 | 5.2 | 25.9 |
| 9 | O | 85 | 59 | 53 | 28 | 5.2 | 26.2 |
| 10 | N | 85 | 60 | 58 | 23 | 5.5 | 27.6 |
| 11 | E | 78 | 55 | 54 | 43 | 6.2 | 30.9 |
| 12 | F | 79 | 56 | 54 | 43 | 7.1 | 35.6 |
| 13 | J | 85 | 55 | 53 | 42 | 8.0 | 40.1 |
| 14 | G | 66 | 55 | 57 | 40 | 10.2 | 51.1 |
| C2 | H | 70 | 57 | 68 | 10 | 12.6 | 63.0 |
| C3 | I | 64 | 58 | 78 | 12 | 14.5 | 72.3 |

The data in TABLE 4 show that higher advancing contact angles vs. water (i.e., higher water repellency) and higher receding contact angles vs. n-hexadecane (i.e., indicating better soil release and release of oil-based stains) were achieved with the lower weighted average HLB value/lower % PEO urethanes, including Urethane K. However, the carpet sample treated with Urethane K additionally showed poor repellency to water, possibly due to poor coalition of the urethane particles upon drying. Carpet samples treated with Urethanes H and I, having high PEO content, provided low receding contact angles to n-hexadecane and, additionally, also demonstrated poor repellency to water. All advancing contact angles vs. n-hexadecane were at least 480, indicating some oil repellency. All receding contact angles to water were at least 55°, indicating good release of water-based stains.

### Examples 15-17 and Comparative Examples C4-C5

Urethane A (0.8/0.2/1.0 C₁₈H₃₇OH/MPEG 750/DES N-100) was evaluated as an ambient cure water repellent treatment for carpet, alone and in combination with a stainblocker and an anti-soiling agent.

The emulsion of Urethane A was diluted with water and was applied at 0.52 g (solids)/ft² to a TRANS III nylon carpet sample using sprayer application. The treated carpet sample was allowed to dry and cure for 68 hours at ambient temperature. After curing, the carpet sample was tested and was found to have a strikethrough time for deionized water of 367 seconds, a strikethrough time for 90/10 water/IPA of 60 seconds, and a stiffness rating of +2 as compared to untreated carpet.

A second carpet sample was treated with FC-672 stainblocker alone at 0.12 g/ft² (solids).

A third carpet sample was treated with a combination of Urethane A (solids) at 0.30 g/ft² and FC-672 stainblocker (solids) at 0.12 g/ft² (a 2.5: 1 ratio of Urethane A: FC-672).

A fourth carpet sample was treated with a combination of Urethane A (solids) at 0.30 g/ft² and EMA/MMA copolymer anti-soiling agent at 0.90 g/ft² (solids) (a 1:3 ratio of Urethane A: FC-672).

A fifth carpet sample was left untreated.

Stain resistance and “Walk-On” soil resistance were measured for each carpet sample, with results presented below in TABLE 5, measured both as Δa and ΔE values, respectively, and as percent improvement vs. the untreated carpet.

TABLE 5

| | | Staining: | | W-O Soiling: | |
|---|---|---|---|---|---|
| | | | % | | % |
| Ex. | Treatment | Δa | improved | ΔE | improved |
| 15 | Urethane A | 35.0 | −11 | −7.3 | −21.8 |
| C4 | FC-672 Stainblocker | 8.7 | +281 | −4.5 | +27.8 |
| 16 | 2.5:1 Urethane A: FC-672 | 9.4 | +242 | −4.1 | +39.0 |
| | Stainblocker | | | | |
| 17 | 1:3 Urethane A: EMA/MMA | 30.0 | +6.7 | −3.5 | +61.9 |
| | Anti-Soiling Agent | | | | |
| C5 | Untreated | 32.0 | 0 | −5.7 | 0 |

The data in TABLE 5 show that addition of the FC-672 stainblocker to the urethane enhanced both the stain resistance and the soil resistance of the treated carpet. Addition of the EMA/MMA copolymer anti-soiling agent slightly improved the stain resistance but greatly improved the soiling resistance of the urethane.

### Example 18

A mixture of Urethane D (0.85/0.15/1.0 C₁₈H₃₇OH/MPEG 750/DES N-75BA) urethane and Polymer I stainblocker was evaluated as an ambient cure water repellent, stainblocking and anti-soiling treatment for carpet.

Using a sprayer application, Urethane D and Polymer I were co-applied at 0.37 g/ft² (0.034 g/m2) of Urethane D solids and 0.126 g/ft² (0.011 g/m²) of Polymer I solids to TRANS III carpet (3: 1 ratio of urethane: stainblocker). The treated carpet was dried at ambient lab temperature (i.e., at 67-70° F. , or 19-21° C.) for 24 hours before testing. Then strikethrough times to deionized water were periodically measured with the following results: 10-15 seconds after 24 hours, 30 seconds after 48 hours, 30-45 seconds after 72 hours, and measurements of no more than 50 seconds after 4 days, showing no further cure. Strikethrough time to water for the treated carpet was >45 seconds after the “Walk-On” test. Based on 4 cycles of “Walk-On” tests, the antisoiling performance of the treated carpet improved by 26% over the untreated carpet.

### Examples 19-28 and Comparative Examples C6-C7

For this series of experiments, Urethanes C, A, F, G, H and I were applied as aqueous dispersions at varying levels to TRANS III carpet (grams of solids/ft² carpet) using spray application. Treated carpets were allowed to dry and cure under ambient conditions for 48 hours before testing. Then carpets were tested for stiffness, strikethrough time (STT) and soil resistance (“walk-on” soiling). Results are presented in TABLE 6.

TABLE 6

| | | | Application | | | W-O |
|---|---|---|---|---|---|---|
| | | | Level, | Stiffness | STT | Soiling |
| Ex. | Urethane | HLB | g/ft² (g/m²) | Rating | (sec) | (ΔE) |
| 19 | C | 2.8 | 0.19 (0.017) | 0 | * | * |
| 20 | | | 0.32 (0.028) | 0 | * | * |
| 21 | | | 0.48 (0.043) | 0 | * | * |
| 22 | A | 5.1 | 0.18 (0.016) | 0 | 35 | −2 |
| 23 | | | 0.30 (0.027) | 0 | 90 | −2 |
| 24 | | | 0.46 (0.041) | 0 | 148 | −2.5 |
| 25 | F | 7.1 | 0.16 (0.014) | 0 | 1 | −2.5 |
| 26 | | | 0.28 (0.025) | 0 | 2 | −3 |
| 27 | | | 0.42 (0.037) | 0 | 6 | −3 |
| 28 | G | 10.2 | 0.42 (0.037) | 0 | 0 | −4 |
| C6 | H | 12.6 | 0.44 (0.040) | 0 | 0 | −4 |
| C7 | I | 14.5 | 0.46 (0.047) | 0 | 0 | −5 |

*Poor fiber coverage due to coagulation of emulsion

The data in TABLE 6 show that all the treated carpet samples showed a stiffness comparable to untreated carpet. Strikethrough times were optimum with Urethane A, having an average weighted HLB value of 5.1, with higher application densities providing higher strikethrough times. Soil resistance was also better with lower average weighted HLB value urethanes except for Urethane C, which did not adequately cover and protect the carpet fibers.

### Examples 29-34

Urethane A was evaluated alone and in various combinations with FC-672 stainblocker and EMA/MMA copolymer as an ambient cure treatment for carpet. Each emulsion was applied at 20 g/ft² (215 g/m²) to TRANS III carpet samples using sprayer application at various component concentrations, the treated carpet samples were allowed to dry and cure for 96 hours at ambient conditions, then the carpet samples were evaluated for strikethrough time, soil resistance and stain resistance. Results are presented in TABLE 7.

TABLE 7

| | | g/ft² (m/ft²) of | | |
|---|---|---|---|---|
| | | solids applied | Strikethrough | |
| Ex. | Component | to carpet | time (sec) | General Comments |
| 29 | Urethane A | 0.20 (0.018) | >180 | Water repellency; soiling |
| | | | | comparable to untreated carpet; no |
| | | | | stain resistance |
| 30 | Urethane A | 0.32 | 90 | Water repellency; soiling |
| | FC-672 | 0.16 | | comparable to untreated carpet; |
| | | | | some stain resistance |
| 31 | Urethane A | 0.32 | 60 | Moderate water repellency; some |
| | FC-672 | 1.00 | | antisoiling; excellent stain |
| | | | | resistance |
| 32 | Urethane A | 0.32 | 45 | Water repellency; some |
| | EMA/MMA | 0.60 | | antisoiling; no stain resistance |
| 33 | Urethane A | 0.32 | 41 | Water repellency; excellent |
| | FC-672 | 0.16 | | antisoiling; good stain resistance |
| | EMA/MMA | 0.60 | | |
| 34 | Urethane A | 0.35 | 44 | Good water repellency, good |
| | FC-672 | 0.20 | | antisoiling; good stain resistance |
| | EMA/MMA | 0.48 | | |

The data in TABLE 7 show that treating a carpet with a combination of a urethane of this invention, a stainblocker and an anti-soiling agent, and allowing the treatment to dry and cure under ambient conditions provides a treated carpet with good combination of water repellency, soil resistance and stain resistance.

### Examples 35-37

Urethane D was applied to three different upholstery fabrics by dipping each fabric in a treating solution containing Urethane D and squeezing out excess solution using a two roller nip. In one set of samples, the wet fabric was allowed to dry under ambient conditions. In a second set of samples, part of each ambient cured treated fabric was further cured in a forced air oven for 5 minutes at 250° F. (121° C.). The three treated upholstery fabrics were as follows:

PES/Cot=Style 7436 polyester/cotton, available from Test Fabrics, Inc., P.O. 420, Middlesex, N.J. 08846, USA.

Cot=Style 428 cotton, available from from Test Fabrics, Inc., P.O. 420, Middlesex, N.J. 08846, USA.

Olefin=Style 4 olefin velvet, fiber only, available from Joan Fabrics Corp., 27 Jackson Street, Lowell, MA, 01852, USA.

The cured treated fabrics were then rated for water repellency using the 12-point scale water repellency test, with results presented in TABLE 8.

TABLE 8

| | Application | | | |
|---|---|---|---|---|
| | Density, | | Water Repellency After: | |
| Ex. | g/ft² (g/m²) | Fabric | Ambient Cure | Oven Cure |
| 35 | 0.56 (6.2) | PES/Cot | 6 | 12 |
| 36 | 0.40 (5.5) | Cot | 8 | 11 |
| 37 | 0.40 (5.5) | Olefin | 3 | 9 |

Urethane D imparted water repellency to each upholstery fabric after ambient cure. Water repellency was further enhanced after a post-ambient cure of 5 minutes at 250° F. (121° C.).

We claim:

1. A finishing composition that is dispersible in water comprising a urethane comprising the reaction product of:
(a) a polyisocyanate;
(b) a long chain alcohol; and
(c) a polyethylene oxide containing at least one hydroxy group,
wherein the urethane has a weighted average hydrophilic/lipophilic balance (HLB) ranging from about 1 to about 11.

2. The finishing composition of claim 1, wherein the polyisocyanate comprises a triisocyanate.

3. The finishing composition of claim 3, wherein the long chain alcohol contains about 12 to about 24 carbon atoms.

4. The finishing composition of claim 1, wherein the long chain alcohol is a stearyl alcohol.

5. The finishing composition of claim 1, wherein the polyethylene oxide comprises a monomethoxy polyethylene oxide containing one hydroxy group.

6. The finishing composition of claim 5, wherein the monomethoxy polyethylene oxide has a molecular weight ranging from about 350 to about 2000.

7. The finishing composition of claim 1, wherein the urethane comprises the reaction product of a triisocyanate, a monomethoxy polyethylene oxide containing one hydroxy group, and stearyl alcohol.

8. The finishing composition of claim 1, wherein the weighted average HLB value is in the range of about 2 to about 8.

9. The finishing composition of claim 1, wherein the weighted average HLB value is in the range of about 4 to about 7.

10. The finishing composition of claim 1, wherein the polyethylene oxide ranges from about 5 to about 55 weight percent based on the weight of the urethane.

11. The finishing composition of claim 1, wherein the polyethylene oxide ranges from about 10 to about 40 weight percent based on the weight of the urethane.

12. The finishing composition of claim 1, wherein the polyethylene oxide ranges from about 20 to about 35 weight percent based on the weight of the urethane.

13. The finishing composition of claim 1, wherein the polyethylene oxide comprises between 1 and about 200 ethylene oxide units.

14. A finishing composition dispersible in water comprising:
(a) a urethane comprising the reaction product of:
(i) a polyisocyanate;
(ii) a polyethylene oxide having at least one hydroxy group,
wherein the urethane has a weighted average hydrophilic/lipophilic balance (HLB) ranging from about 1 to about 11; and
(b) a stainblocker, an anti-soiling agent, or mixtures thereof.

15. The finishing composition of claim 14, wherein the polyisocyanate comprises a triisocyanate.

16. The finishing composition of claim 14, further comprising a long chain alcohol containing about 12 to about 24 carbon atoms.

17. The finishing composition of claim 14, wherein the long chain alcohol is a stearyl alcohol.

18. The finishing composition of claim 24, wherein the polyethylene oxide comprises a monomethoxy polyethylene oxide containing one hydroxy group.

19. The finishing composition of claim 18, wherein the monomethoxy polyethylene oxide has a molecular weight ranging from about 350 to about 2000.

20. The finishing composition of claim 14, wherein the urethane comprises the reaction product of a triisocyanate, a monomethoxy polyethylene oxide containing one hydroxy group, and stearyl alcohol.

21. The finishing composition of claim 14, wherein the polyethylene oxide comprises a polyethylene oxide group and a (C₁-C₂₄) alkoxy group.

22. The finishing composition of claim 14, wherein the polyethylene oxide comprises between 1 and about 200 ethylene oxide units.

23. The finishing composition of claim 14, wherein the weighted average HLB value is in the range of about 2 to about 8.

24. The finishing composition of claim 14, wherein the weighted average HLB value is in the range of about 4 to about 7.

25. The finishing composition of claim 14, wherein the urethane has a total polyethylene oxide content between about 5 and about 55 weight percent the based on the weight of the urethane.

26. The finishing composition of claim 14, wherein the urethane has a total polyethylene oxide content between about 10 and about 40 weight percent based on the weight of the urethane.

27. The finishing composition of claim 14, wherein the urethane has a total polyethylene oxide content between about 20 and about 35 weight percent based on the weight of the urethane.

28. The finishing composition of claim 14, wherein the stainblocker comprises a sulfonated aromatic polymer.

29. The finishing composition of claim 28, further comprising a divalent metal salt.

30. The finishing composition of claim 14, wherein the stainblocker is a polymer comprising the reaction product of one or more acrylic acid monomers.

31. The finishing composition of claim 30, wherein one or more of the acrylic acid monomers comprises an α-substituted or β-substituted acrylic acid.

32. The finishing composition of claim 31, wherein one or more of the acrylic acid monomers comprise methacrylic acid.

33. The finishing composition of claim 14, wherein the stainblocker is a polymer comprising the reaction product of one or more ethylenically unsaturated monomers and maleic anhydride.

34. The finishing composition of claim 33, wherein one or more of the ethylenically unsaturated monomers comprises an alpha-olefin.

35. The finishing composition of claim 34, wherein the alpha-olefin comprises an alkene having from about 4 to about 12 carbon atoms.

36. A finishing composition of claim 14, wherein the anti-soiling agent comprises a methacrylic ester polymer.

37. A finishing composition of claim 14, wherein the anti-soiling agent comprises a colloidal alumina.

38. A finishing composition of claim 14, wherein the anti-soiling agent comprises a colloidal silica.

39. A finishing composition of claim 14, wherein the anti-soiling agent comprises a silsesquioxane.

40. A finishing composition of claim 14, wherein the anti-soiling agent comprises a polyvinylpyrrolidone.

41. A finishing composition of claim 14, wherein the anti-soiling agent comprises a water-soluble condensation polymer comprising the reaction product of formaldehyde and an amine.

42. A method of treating a fibrous substrate comprising the steps of:
(a) applying to the fibrous substrate a water dispersible urethane according to claim 1; and
(b) curing the finishing composition at or above ambient temperature.

43. The method of claim 42, wherein the finishing composition is cured at ambient temperature.

44. The method according to claim 42, wherein the urethane comprises the reaction product of a triisocyanate, a monomethoxy polyethylene oxide containing one hydroxy group, and stearyl alcohol.

45. A method of treating a fibrous substrate comprising the steps of:
(a) applying to the fibrous substrate a water dispersible finishing composition according to claim 14; and
(b) curing the finishing composition at or above ambient temperature.

46. The method of claim 45, wherein the finishing composition is cured at ambient temperature.

47. The method of claim 45, wherein the urethane comprises the reaction product of a triisocyanate, a monomethoxy polyethylene oxide containing one hydroxy group, and stearyl alcohol.

48. The method of claim 45, wherein the polyethylene oxide comprises a polyethylene oxide group and a (C₁₂-C₂₄) alkoxy group.

49. A treated fibrous substrate comprising a fibrous substrate and a finishing composition according to claim 1.

50. The treated fibrous substrate of claim 49, wherein the fibrous substrate is a carpet.

51. A treated fibrous substrate comprising a fibrous substrate and a finishing composition according to claim 14.

52. The treated fibrous substrate of claim 51, wherein the fibrous substrate is a carpet.
